(19) United States
(12) Patent Application Publication
(10) Pub. No.: US 2024/0319784 A1
(43) Pub. Date: Sep. 26, 2024

(54) METHODS, APPARATUSES, SYSTEMS AND COMPUTER PROGRAM PRODUCTS FOR SMART MESSAGE DELIVERY AND SYSTEMS AND METHODS FOR CAPTURING MOMENTS IN THE PAST

(71) Applicant: META PLATFORMS, INC., Menlo Park, CA (US)

(72) Inventors: Alexander Faaborg, Mountain View, CA (US); Joseph Gardner, Burlingame, CA (US); Mark Chichester, San Francisco, CA (US); Scott Gary, Brooklyn, NY (US)

(21) Appl. No.: 18/437,829

(22) Filed: Feb. 9, 2024

Related U.S. Application Data
(60) Provisional application No. 63/491,650, filed on Mar. 22, 2023.
(60) Provisional application No. 63/495,444, filed on Apr. 11, 2023.

(51) Int. Cl. G06F 3/01; G06F 3/16; H04L 67/12

(52) U.S. Cl. CPC G06F 3/011; G06F 3/165; G06F 3/017; H04L 67/12

(57) ABSTRACT

Systems and methods for smart message delivery for message handoff between communication devices and artificial reality systems are provided. In various examples, a communication device or HMD may receive a message initiating a detection of motion(s) and/or position(s) of the communication device and/or the HMD associated with a user with respect to each other. The communication device and/or the HMD may determine a movement level associated with each other, and based on the movement level relative to a predetermined threshold a message delivery process may be determined. If the predetermined threshold is not met, the message may be output to a user via audio and if the predetermined threshold is met, text associated with the message may be presented by the communication device for the user to read. The system may further monitor the movement level while the message is being output to the user, and if the predetermined threshold is no longer met, the message may be output to the user via audio by the HMD based on where the user stopped reading text of the message. In situations where the movement level increases to meet or exceed the predetermined threshold, the message may be output via text by the communication device, and the text corresponding to the portion of the message read aloud as audio by the HMD may be in a different format to enable the user to easily determine where to start reading the message.

### CROSS-REFERENCE TO RELATED APPLICATIONS

This application claims the benefit of both U.S. Provisional Application No. 63/491,650 filed Mar. 22, 2023 and U.S. Provisional Application No. 63/495,444 filed Apr. 11, 2023, the entire content of which is incorporated herein by reference.

### TECHNOLOGICAL FIELD

The present disclosure generally relates to methods, apparatuses, and/or computer program products for delivering messages to artificial reality devices utilizing detected movements.

### BACKGROUND

Electronic devices are constantly changing and evolving to provide users with flexibility and adaptability. With increasing adaptability in electronic devices, many users are keeping their devices on their person during various everyday activities. Constantly having multiple electronic devices on your person may lead to repeated and annoying notifications disrupting user experience. An example of such an instance, where this may be particularly apparent is with artificial reality devices.

Artificial reality is a form of immersive reality that has been adjusted in some manner before presentation to a user, which may include, for example, a virtual reality, an augmented reality, a mixed reality, a hybrid reality, Metaverse reality or some combination or derivative thereof. Artificial reality content may include completely computer-generated content or computer-generated content combined with captured (e.g., real-world) content. The artificial reality content may include video, audio, haptic feedback, or some combination thereof, any of which may be presented in a single channel or in multiple channels (such as stereo video that produces a three-dimensional (3D) effect to the viewer). Additionally, in some instances, artificial reality may be associated with applications, products, accessories, services, or some combination thereof, that may be used to, for example, create content in an artificial reality or are otherwise used in (e.g., to perform activities in) an artificial reality. Head-mounted displays (HMDs) including one or more near-eye displays may often be used to present visual content to a user for use in artificial reality applications.

Due to the current environment with electronic devices, many users may utilize HMDs with another external device such as a phone or smart watch, and it has become more common for users to experience increased stimulus and noise in instances in which two or more devices alert an incoming message at the same time. Experiencing stimulus and noise from two or more devices pertaining to the same alert regarding an incoming message may be cumbersome to a user as it may be unclear to the user which of the two devices to check first regarding the incoming message and if the stimulus and noise really pertain to the same incoming message. In view of the foregoing drawbacks, it may be beneficial to provide an efficient and reliable method for delivering messages to only one device at a time.

### BRIEF SUMMARY

Disclosed herein are methods, apparatuses, computer program products and/or systems for delivering messages between HMDs and other electronic devices (e.g., smartphones, tablets, smartwatches, or any electronic device capable of communicating with an HMD).

The examples of the present disclosure may both determine which of multiple devices to deliver an incoming/received message to, and also may seamlessly transition between which of the devices is reading out audio of the message or displaying the message, based in part on determining one or more predetermined gestures. For instance, in some examples the one or more predetermined gestures may be a wrist raise gesture determined by an inertial measurement unit (IMU) on a communication device (e.g., a smart watch) and a looking down at device gesture determined by an IMU on another communication device (e.g., smart glasses). Other suitable predetermined gestures are also contemplated by the examples of the present disclosure.

Additionally, in some other examples of the present disclosure, either of the predetermined gestures may be detected by one or more cameras on either of the multiple devices (e.g., in addition to or instead of utilizing IMUs).

In an example, a method of smart message delivery may include receiving a message; detecting a relative position and motion associated with an electronic device; obtaining inertial movement associated with the electronic device; determining modality to deliver the message; delivering the message, based on the determination of the modality; and monitoring inertial movement of the electronic device during message delivery.

In another example, a method of smart message delivery may include receiving a message; detecting a relative position and motion associated with a HMD; obtaining inertial movement associated with the HMD; determining a modality to deliver the message; delivering the message, based on the determination of the modality; and monitoring inertial movement of the HMD during message delivery.

In yet another example, a method of smart message delivery may include receiving a message; detecting a relative position and motion associated with a HMD and an electronic device; obtaining inertial movement associated with the HMD and electronic device; determining a modality to deliver the message; delivering the message, based on the determination of the modality; and monitoring inertial movement of the HMD and the electronic device during message delivery.

In yet another example, a method of smart message delivery may include receiving a message, determining a relative position and motion associated with a HMD and an electronic device, via a camera, and determining a modality to deliver the message; delivering the message, based on the determination of the modality; and monitoring a view of the camera during message delivery.

In yet another example, a method of smart message delivery may include receiving a message; determining a status of a user; determining a modality to deliver the message, based on the status; and delivering the message based on the determination of the modality.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 illustrates an example head-mounted display according to an example of the present disclosure.

FIG. 2 illustrates an example environment for smart message delivery according to an example of the present disclosure.

FIG. 3 illustrates a smart message delivery system in accordance with an example of the present disclosure.

FIG. 4 illustrates a method of smart message delivery in accordance with an example of the present disclosure.

FIG. 5 illustrates an example block diagram of a head-mounted display device, in accordance with an example of the present disclosure.

FIG. 6 illustrates an example processing system, in accordance with an example of the present disclosure and an example schematic of an example processing system that may implement a recording system, in accordance with another example of the present disclosure.

FIG. 7 illustrates an exemplary user interface of a communication device in an instance in which another communication device outputs audio of content associated with a received/incoming message according to an example of the present disclosure.

FIG. 8 illustrates an example device, in accordance with an example of the present disclosure.

FIG. 9 is an example flow diagram illustrating a method of video recording in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, “artificial reality” may refer to a form of immersive reality that has been adjusted in some manner before presentation to a user, which may include, for example, a virtual reality (VR), an augmented reality, a mixed reality, a hybrid reality, Metaverse reality or some combination or derivative thereof. Artificial reality content may include completely computer-generated content and/or computer-generated content combined with captured (e.g., real-world) content. In some instances, artificial reality may be associated with applications, products, accessories, services, and/or some combination thereof that may be used to, for example, create content in an artificial reality or otherwise used in (e.g., to perform activities in) an artificial reality.

As referred to herein, “artificial reality content” may refer to content such as, for example, video, audio, haptic feedback, and/or some combination thereof, any of which may be presented in a single channel or in multiple channels (e.g., such as stereo video that produces a three-dimensional effect to the viewer) to a user.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional virtual worlds, online games (e.g., video games), one or more content items such as, for example, images, videos, non-fungible tokens (NFTs) and in which the content items may, for example, be purchased with digital currencies (e.g., cryptocurrencies) and/or other suitable currencies. In some examples, a Metaverse or Metaverse network may enable the generation and provision of immersive virtual spaces in which remote users can socialize, collaborate, learn, shop and engage in various other activities within the virtual spaces, including through the use of Augmented/Virtual/Mixed Reality.

It is to be understood that the methods and systems described herein are not limited to specific methods, specific components, or to particular implementations. It is also to be understood that the terminology used herein is for the purpose of describing particular embodiments only and is not intended to be limiting.

### A. Methods, Apparatuses, Systems and Computer Program Products for Smart Message Delivery

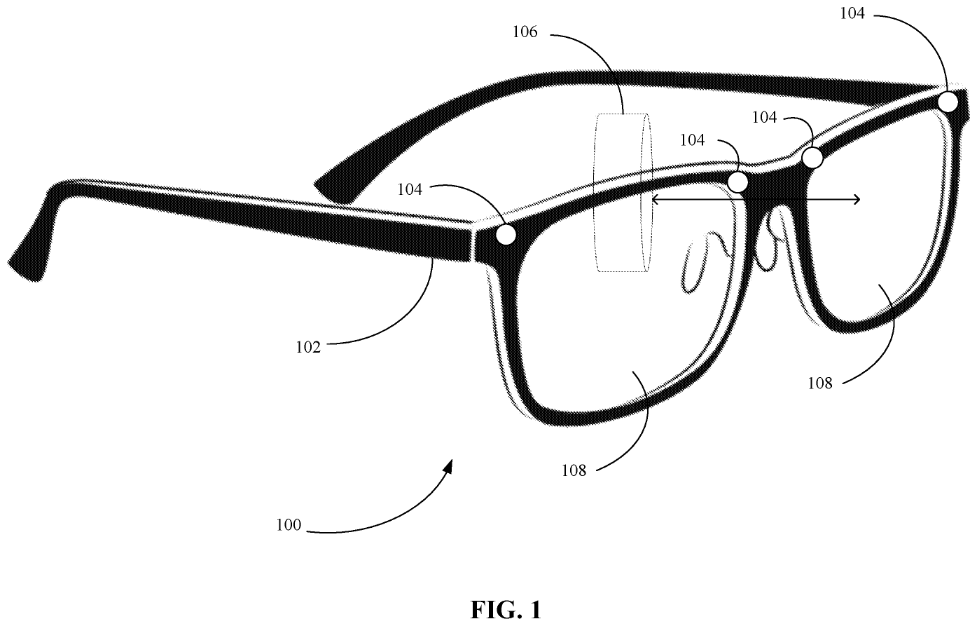

The present disclosure is generally directed to systems, apparatuses, computer program products and methods of smart message delivery via audio and/or text utilizing, in part, a communicative link between an electronic device and an HMD. FIG. 1 illustrates an example HMD 100 associated with artificial reality content. HMD 100 may include enclosure 102 (e.g., an eyeglass frame), one or more cameras 104, a display(s) 108. The display(s) 108 may be configured to direct images to a surface 106 (e.g., a user's eye or another structure). In some examples, HMD 100 may be implemented in the form of augmented-reality glasses. Accordingly, display(s) 108 may be at least partially transparent to visible light to allow the user to view a real-world environment through the display 108(s).

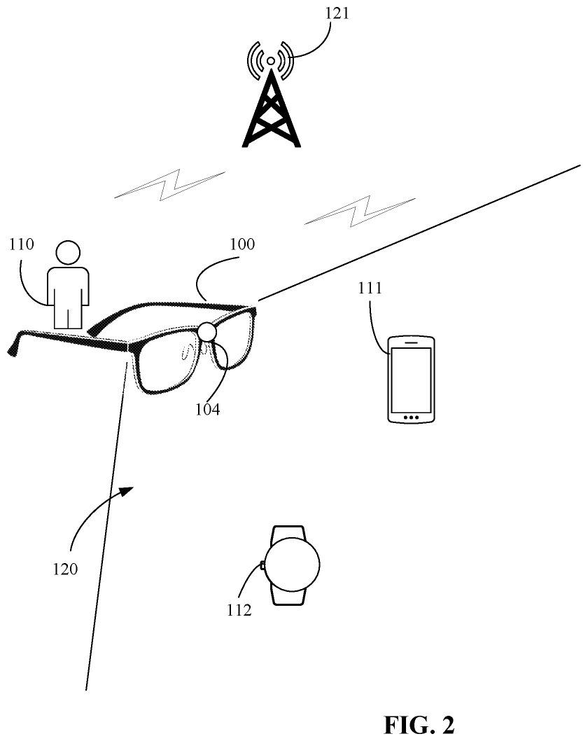

Tracking of surface 106 may be beneficial for graphics rendering or user peripheral input. In many systems, HMD 100 design may include one or more cameras 104 (e.g., a front facing camera(s) away from a primary user 110 of FIG. 2 or a rear facing camera(s) towards a primary user 110). Camera(s) 104 may track movement (e.g., gaze) of an eye(s) of primary user 110 or line of sight associated with primary user 110. HMD 100 may include an eye tracking system to track the vergence movement of primary user 110. Camera(s) 104 may capture images and/or videos of an area, or capture video and/or images associated with surface 106 (e.g., eyes of primary user 110 or other areas of the face of the primary user 110) depending on the directionality and view of camera(s) 104. In examples in which camera(s) 104 is rear facing towards a primary user 110, camera(s) 104 may capture images and/or videos associated with surface 106. In examples in which camera(s) 104 is front facing away from primary user 110, camera(s) 104 may capture images and/or videos of an area. HMD 100 may be designed to have both front facing and rear facing cameras (e.g., camera(s) 104). There may be multiple cameras 104 that may be used to detect the reflection off of surface 106 and/or other movements (e.g., glint(s) or any other suitable characteristic(s)). Camera(s) 104 may be located on frame 102 in different positions. Camera(s) 104 may be located along a width of a section of frame 102. In some other examples, the camera(s) 104 may be arranged on one side of frame 102 (e.g., a side of frame 102 nearest to the eye). Alternatively, in some examples, the camera(s) 104 may be located on display(s) 108. In some examples, camera(s) 104 may be a sensor(s) or a combination of cameras and sensors to track one or more eyes (e.g., surface 106) of a user (e.g., primary user 110).

FIG. 2 illustrates an exemplary environment for smart message delivery. Primary user 110 may be associated with HMD 100, mobile device 111, or smartwatch 112. Primary user 110 may also be referred to herein as user 110. In some examples, users (e.g., users 110) may be associated with devices based on being linked to associated user profiles. Base station 121 may be configured to provide wide area network access (e.g., cellular system access) and/or local area network access (e.g., Wi-Fi). The HMD 100, mobile device 111, or smartwatch 112, may be communicatively connected with each other directly (e.g., via Bluetooth, near field communication, ultra-wideband, or any other suitable form of communicative connection) and/or connected by the base station 121. Line-of-sight (LOS) area 120 may be based on a determination of the gaze of primary user 110 and/or a video (or image) capture area of camera(s) 104 of HMD 100.

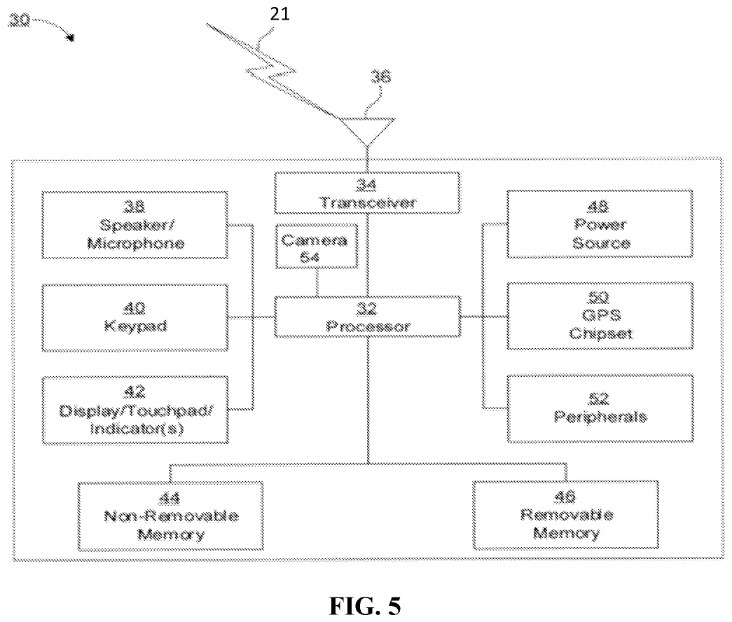

In an example, an inertial measurement unit (IMU) (e.g., IMU 56 of FIG. 5) may be used to determine whether the inertial movement of smartwatch 112, mobile device 111, or HMD 100 should be used as a trigger for smart message delivery. The IMU may be calibrated for different muscle and body movements associated with a user (e.g., user 110). In some examples, artificial intelligence (AI) may be used to determine the triggers for smart message delivery. In some other examples, inertial movement of smartwatch 112, mobile device 111, or HMD 100 may be determined via eye-gaze tracking (EGT), electromyography (EMG), and/or any other suitable manner to determine inertial movement.

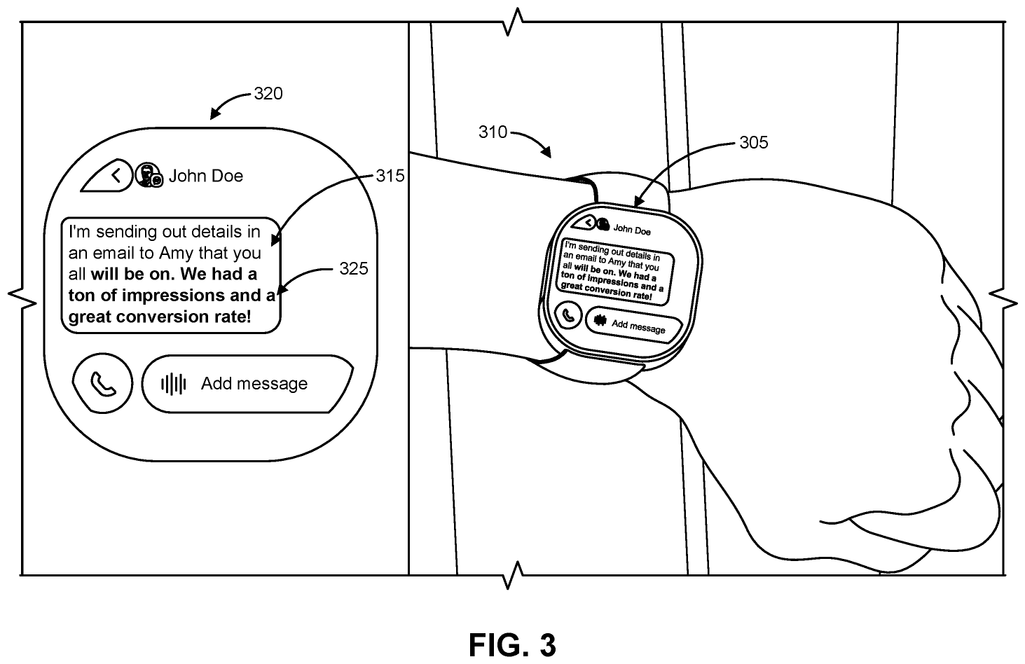

FIG. 3 illustrates a smart messaging system in accordance with an example of the present disclosure. FIG. 3 may illustrate the view a user (e.g., user 110) sees in an instance in which the user looks through the display (e.g., display 108) of an HMD (e.g., HMD 100). The user 110 wearing an HMD (e.g., HMD 100) may receive a message 320 on a communicatively connected device 310 (e.g., mobile device 111, smartwatch 112, or any other suitable device). In some examples, the message 320 may be a short message service (SMS) message, multimedia messaging service (MMS) message, notification(s) (e.g., notifications generated by applications (apps), etc.), alert(s), or other suitable message(s). In some conventional/existing systems when a user 110 receives a message 320 via device 310, the device 310 may communicate with an HMD 100 to provide a user 110 with audio corresponding to the text of a message. In the example of FIG. 3 of the present disclosure, audio may begin to play via the HMD 100 in response to the HMD 100 detecting receipt of a message (e.g., an incoming message) from another device (e.g., mobile device 111). In this regard, the HMD 100 may read and present audio of the message 320 (e.g., an SMS) to the user 110, allowing the user 110 to hear the audio of the content that was sent, via message 320, to device 310. In some alternative examples, message 320 may be an audio message and in such examples, the device 310 may convert the audio message to text. In this regard, for example, the user 110 may select a setting via the device 320 to enable the device 310 to convert an audio message to text.

In some examples, the text of a message (e.g., message 320) that is being read/converted to audio by the HMD 100 may be presented to a user (e.g., user 110) by a user interface (e.g., user interface 305) of the device 310 in response to the device 310 detecting a gesture of the user. For example, in response to the user raising or lifting a body part (e.g., a wrist) wearing the device 310, to perform a wrist raise gesture, the HMD 100 may stop reading aloud the audio output associated with the message and may present, via the UI 305, the text of the message (e.g., message 320) to the user. In some examples, the IMU of device 310 may determine that the body part (e.g., a wrist) is raised to a predetermined threshold level in order to detect/determine the wrist raise gesture. Additionally, in some examples, the IMU associated with the device 310 may detect the gesture (e.g., wrist raise gesture) based on the movement of the body part and may trigger a processor (e.g., processor 32 of FIG. 5) of the device 310 to communicate with the HMD 100 to stop reading the audio of the message and to provide the message (e.g., message 320) to the device 310 to present the message via the UI 305. In some examples, the processor of the device 310 may communicate, by Bluetooth or some other near field communication, with the HMD 100 to stop reading the audio of the message and to provide the message to the device 310. In other examples, the processor of the device 310 may communicate with the HMD 100 by sending a communication to base station 121 enabling the base station 121 to send a message to the HMD 100 instructing the HMD 100 to stop reading the audio of the message and instructing the HMD 100 to provide the message to the device 310.

The device 310 may determine which portion of the message has already been read aloud (e.g., output as audio) by the HMD 100 and which portion of the message has not been read aloud by the HMD 100 in response to detecting the gesture. In this regard, for example, the device 310 may present the content 315 (e.g., text) of the message 320 that has already been read aloud (e.g., output as audio) by the HMD 100 in a different format such as, for example, presented in a different/first font (e.g., a gray font). In the example of FIG. 3, the device 310 determined that the content 315 associated with “I'm sending out details in an email to Amy that you all” was already read aloud (as audio output) by the HMD 100. Additionally, the device 310 determined that another portion of the message was unread aloud as audio output by the HMD 100 and may present this portion of content 325 of the message (e.g., message 320) in another format (e.g., a different/second font) via the UI of the device 310. For instance, in the example of FIG. 3, the device 310 determined that the portion of content 325 of the message associated with “will be on. We had a ton of impressions and a great conversion rate!” was unread read aloud (e.g., not output as audio) by the HMD 100.

In the some examples, audio output, by the HMD 100, corresponding to message 320 may immediately stop, gradually fade during a predetermined time period (e.g., a predetermined number of seconds) then stop, or the audio output may be adjusted during the predetermined time period (e.g., a predetermined number of seconds) in an instance in which device 310 is moved in the LOS 120 of HMD 100. In some other examples, audio output, by the HMD 100, corresponding to message 320 may immediately stop, gradually fade during a predetermined time period, then stop, or the audio output may be adjusted during the predetermined time period in an instance in which the HMD 100 moves, associated with head or neck movement of user 110, in a manner similar to looking at device 320 being worn on a body part (e.g., wrist) of a user (e.g., user 110). In this regard, the looking at device 320 by the HMD 100 may be another gesture determined by an IMU (e.g., IMU 56) of the HMD 100. As an example for purposes of illustration and not of limitation, the looking at the device gesture by the HMD 100 may cause/trigger the HMD 100 to stop audio output associated with the message by the HMD 100 and may cause the message to be displayed via the UI of the device 310 for presentation to the user in the manner described above (e.g., as shown in FIG. 3). In some examples, the IMU of the device 310 may determine the rotation/angle of the device 310. In this regard, for purposes of illustration and not of limitation, for example, in an instance in which a user indicates in a user profile that a wrist wearable device (e.g., device 310) is worn on the left wrist, the IMU of the wrist wearable device may determine an instance in which the left wrist is raised (e.g., by detecting the movement) in conjunction with the IMU of the HMD 100 determining the angle of the HMD 100 to determine whether the HMD is viewing the general direction of the wrist device.

An IMU within or associated with device 310 and/or HMD 100 may be an electronic device that measures and determines specific force, angular rate, orientation of a device using one or more (e.g., a combination) of accelerometers, gyroscopes, and/or in some examples magnetometers. An IMU may determine whether a movement (e.g., trigger) of the device 310 and/or HMD 100 has surpassed or reached a predetermined threshold movement. In some examples, this predetermined threshold movement (associated with movement of the device 310 and/or HMD 100) may be stored in a memory (e.g., non-removable memory 44, removable memory 46) of the device 310 and/or HMD 100.

For example, in an instance in which a user receives a message 320, the audio of the message 320 may begin to be output to the user via a component (e.g., speaker/microphone 38) of the HMD 100. For instance, as the message is being read aloud (e.g., audio output) to user 110 by the HMD 100, the user 110 may decide they want to read the message (e.g., the text of the message) and may move the device 310 towards their LOS 120. In some examples, the moving of the device 310 towards the LOS 120 may trigger the looking at the device gesture. In this regard, the audio corresponding to the message (e.g., message 320) output by the HMD 100 may begin to fade or be adjusted during a predetermined time period (e.g., 2 seconds, 3 seconds, etc.) before the audio stops in response to the IMU of the HMD 100 determining that the movement (e.g., the trigger) of the HMD 100 reached or exceeded a predetermined threshold movement (e.g., a first predetermined threshold movement). In another example, if a user receives a message 320, the audio of the message 320 may begin to be output to the user (e.g., via speaker/microphone 38) by the HMD 100. As the message is being read aloud to user 110 by the HMD 100, the user 110 may decide they want to read the message themselves and may move their head or view while wearing the HMD 100 towards device 310, such that device 310 is within the LOS 120 of user 110 wearing the HMD 100. In this regard, the audio corresponding to the message may begin to fade or be adjusted, by the HMD 100, during a predetermined time period (e.g., 2 seconds, 3 seconds, etc.) before audio stops as the IMU of the HMD 100 determines that the movement of the HMD 100 reaches or exceeds the predetermined threshold movement. In some other examples, the audio output by the HMD 100 may fade in relation to, or correlated with, an angle of a body part (e.g., wrist angle) wearing the device 310.

In some other examples, in an instance in which user 110 may be viewing device 310 via the HMD 100 and in an instance in which a message 320 is received as text, for example, by device 310, the audio corresponding to the text of message 320 may not be communicated to user 110 until an IMU of the HMD 100 determines that a movement of the device 310 reaches or exceeds another predetermined movement threshold (e.g., a second predetermined movement threshold). For example, in an instance in which the movement of the device 310 is determined to no longer be in the LOS 120 or field of view of the HMD 100, the audio corresponding to the text of message 320 may then be communicated to user 110.

For purposes of illustration and not of limitation, a message 320 may be received by device 310 while a user 110 is looking at their device 310, and the user may then decide to start walking. Consider that the user may decide to lower their device 310 to their side or put the device 310 in their pocket. In response, the IMU of the HMD 100 may determine that the audio associated with the message 320 may be output to user 110 since the device 310 is moved from the LOS 120 of the HMD 100 (e.g., the device 110 is in the user's 110 pocket or similarly if the user decides to look away from the device 310. In some examples, the user 110 may continuously raise and lower a body part (e.g., a wrist) or a field of view of the HMD 100 such that device 310 may alternate between a first position and a second position (e.g., a position that may initiate audio associated with text of a message in response to determining that device 310 is not in a LOS 120 of user 110) to start and stop transmission of audio associated with text of message 320 depending on the length of the message. In this regard, the user 110 may alternately raise and lower a body part (e.g., a wrist) wearing the device 310 to cause triggering of starting and stopping the audio output by the HMD 100. For purposes of illustration and not of limitation, for example, in an instance in which it takes a minute for audio associated with text of message 320 to be read aloud (e.g., output) by the HMD 100 to user 110, the user 110 may desire to read parts of the message themself and to have parts of other parts of the message read aloud to the user 110 by the HMD 110. In this regard, for example, consider that the user 110 desires to read parts of the message themselves and have parts of the message played to them every 10 seconds. In this regard, the user 110 may alternate every 10 seconds between moving the device 310 (presenting the message 320) in the user's LOS 120 by movement or tilt of their head, or other body part (e.g., a wrist or arm) associated with device 310 such that the user may read parts of the message themself and move the device 310 out of the user's 110 LOS 120 (or out of the HMD's 100 LOS 120) such that the HMD 100 may output the audio associated with the corresponding portion of the message. In this regard, audio associated with the message may be output to user 110 by the HMD 100 for 10 seconds when in the device 110 is out of the LOS of the HMD 100, then the audio may stop as the device 310 is moved in the LOS 120 so that the user 110 may thereafter read a portion of the message, and the cycle may repeat until the entire message is consumed (e.g., read by the user or audio output) by the user 110. In some examples, the audio may be continued from the word or portion of the message that the user 110 may be determined to have stopped reading themself. In some examples, HMD 100 may utilize eye tracing or eye tracking (e.g., by camera(s) 104) to determine gaze, movement, or angle of an eye(s) of the user 110 to determine where user 110 may have stopped reading message 320 before moving the device out of the LOS 120 so that audio output of a corresponding portion of the message may resume from the stopping point.

In some alternative examples, movement or positioning of device 310 in relation to the LOS 120 of user 110 wearing the HMD 100 may be determined via a camera(s) (e.g., camera(s) 104) located on frame 102 of HMD 100. In some examples, the camera(s) 104 may be trained by AI to determine one or more characteristics associated with device 310, such as for example size, surface area, glint, brightness of a UI, or any other suitable characteristic(s) to determine an instance in which device 310 is within view of camera 104 to cause the HMD 100 to stop transmission of audio associated with the message (e.g., message 320) and/or cause/instruct the device 310 to present/display the message (e.g., via the UI 305).

In other alternative examples, the device 310 and/or HMD 100 may determine instances in which to output message 320 as text or audio to a user 110 based on the environment of the user 110. For example, in an instance in which user 110 may be actively listening or in a conversation associated with a predefined time period/interval (e.g., a predetermined number of seconds), a microphone (e.g., speaker/microphone 38) of device 310 and/or HMD 100 may capture audio associated with a conversation to enable the device 310 and/or HMD 100 to determine that a conversation is occurring. In an instance in which user 110 is determined to be actively listening or in a conversation, the message 320 may be presented to user 110 by device 310 via text thus prioritizing the conversation user 110 may already be having. As referred to herein, a conversation may refer to any form of communication between two parties such as face to face, video conference, or any other suitable mode of communication. In another example, consider an instance in which the user 110 is reading (e.g., a paper, a UI of device 310, or any other suitable mode of reading). In such an example, a camera(s) (e.g., camera(s) 104) of HMD 100 may be configured to access the front facing view (e.g., line of sight 120) of user 110 for a predefined time interval (e.g., a predefined number of seconds or any increment of time) and capture an image and/or video of the user reading, in an instance in which the message 320 is detected as being received. In this regard, the HMD 100 may determine that the user is reading. In this example, since the user 110 is determined to be reading, the HMD 100 may output/transmit the audio of the message (e.g., message 320) to user 110.

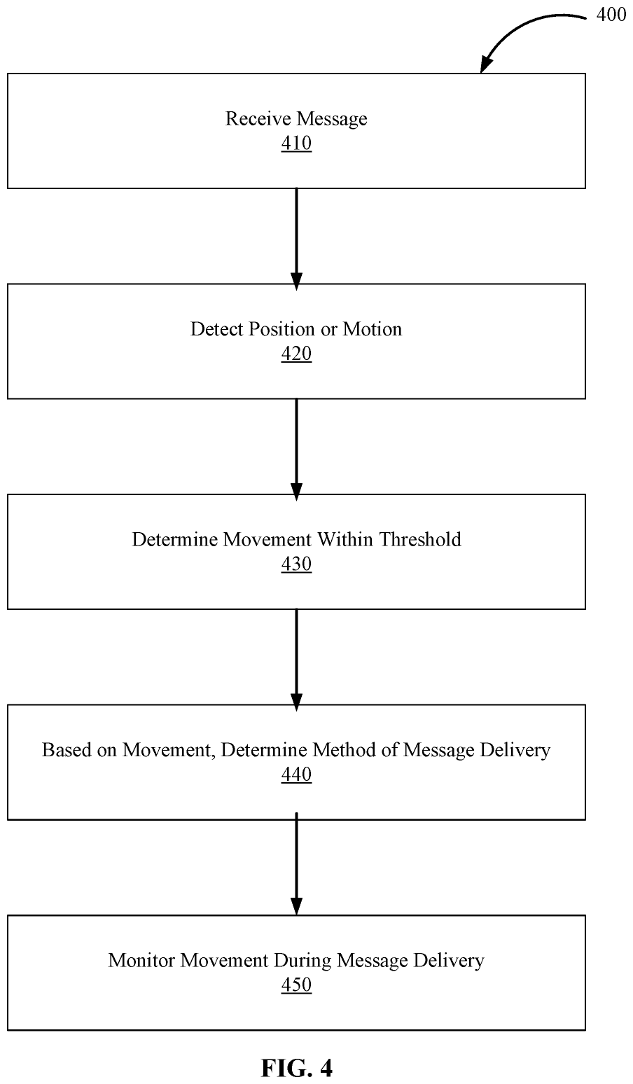

FIG. 4 illustrates a method 400 of smart message delivery in accordance with an example of the present disclosure. At block 410, one or more devices (e.g., HMD 100, device 310) may receive a message (e.g., message 320). For instance, in some examples, each of the one or more devices (e.g., HMD 100, device 310) may receive the message, but one (e.g., HMD 100 or device 310) of the one or more devices may initially present (e.g., audio or via display/UI) the message to a user. In some examples, the message may be sent by another device (e.g., mobile device 111) to the one or more devices.

At block 420, one or more devices (e.g., HMD 100, device 310) may determine a position(s) and/or motion(s) of the one or more devices. The one or more devices may determine their position and/or movement by an IMU (e.g., IMU 56). In some examples, the one or more devices may (e.g., simultaneously) communicate their determined position(s) and/or determined motion(s) to each other. In some other examples, a camera(s) 104 of a first device (e.g., HMD 100) of the one or more devices, may determine position(s) and/or motion(s)/movement(s) of a second device (e.g., device 310), of the one or more devices, within or associated with a predetermined area (e.g., a sector) which may be associated with LOS 120.

At block 430, the one or more devices (e.g., HMD 100, device 310) may determine whether the position(s) and/or motion(s)/movement(s) corresponds to one or more predetermined gestures.

At block 440, the one or more devices (e.g., HMD 100, device 310) may determine, based on the position(s) and/or motion(s)/movement(s) associated with the one or more predetermined gestures a manner in which to deliver/present the message. For example, an IMU of one of a first device (e.g., HMD 100) of one or more devices may determine if a body part (e.g., a wrist) of a user (e.g., user 110) wearing a second device (e.g., device 310) of the one or more devices is positioned within the LOS 120. In an instance in which the first device determines that the body part is positioned within the LOS 120 (e.g., the wrist is down), the first device (e.g., HMD 100) may determine that a first predetermined gesture (e.g., a looking down at device gesture) is invoked. In response to determining the first predetermined gesture is invoked, the first device (e.g., HMD 100) may read aloud the message (e.g., message 320) as audio output to the user (e.g., user 110). message for example raised to meet or exceed a predetermined threshold movement. As another example, an IMU (e.g., IMU 56) of the second device (e.g., device 310) of the one or more devices may determine if a body part (e.g., a wrist) wearing the second device is moved, for example raised, and thereby meets or exceeds a predetermined threshold movement. In response to the second device (e.g., device 310) determining that the body part is moved meeting or exceeding the predetermined threshold movement, the second device may determine that a second predetermined gesture (e.g., a wrist raise gesture) is invoked. In response to determining the second predetermined gesture is invoked, the second device (e.g., device 310) may present the message via a UI (e.g., UI 305) of the second device to enable the user to read the message (e.g., the user 110 reading the message 320 themself).

At block 450, the one or more devices (e.g., HMD 100, device 310) may (e.g., continuously) monitor position(s) and/or motion(s)/movement(s) of the one or more devices during the message delivery/presentation (e.g., output of the message). For example, movement may be continuously monitored by the one or more devices while delivering/presenting (e.g., output of) message 320 to a user (e.g., user 110) via audio or display via a UI. For example, during output of the message by the first device (e.g., HMD 100) in an instance in which the one or more devices detect that second device (e.g., device 310) changes position and moves in the LOS 120 of the first device, the message may be transitioned to the second device to be output/presented (e.g., as text) by the second device. In this example, the message may be converted to text to be presented via a display or UI of the first device to enable the user to read the message themself, and the content of the message that was output/transmitted via audio by the first device (e.g., HMD 100) may be in a different format (e.g., a gray font, other color font designation or other type of designation (e.g., highlighting)) so that the user may determine where the audio output of the content of the message stopped. In another example, in an instance in which output of the message is by the second device (e.g., device 310), when the one or more devices detect that the second device changes position and moves outside of the LOS 120, the message (e.g., message 320) may be transitioned from the second device to be output as audio by the first device (e.g., HMD 100). By implementing the method 400, the smart message delivery mechanism of the present disclosure may reduce stimulus and noise associated with received messages experienced by users and may enable users experiences to be more user friendly and less cumbersome than conventional/existing approaches.

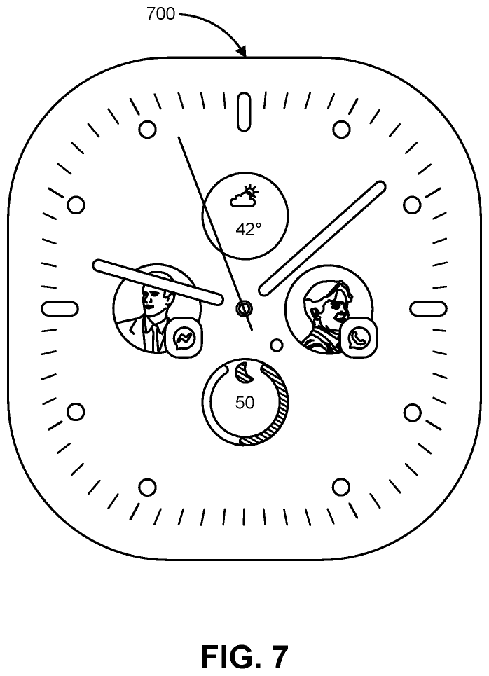

As an additional example of the method(s) of message delivery/output of the present disclosure, consider an example of transitioning a message output from smart glasses (e.g., HMD 100) to a smart watch (e.g., smartwatch 112, device 310). In this example, if the user has their wrist down when wearing the smart watch, the message may initially be delivered to, or output by the smart glasses and may be read out aloud by audio output. In an instance in which the message is initially delivered to, or output as audio by the smart glasses, the smart watch may take no action regarding the message (e.g., as shown by the smart watch UI 700 of FIG. 7). If the message is a very long message, or if the user simply prefers to read the text of the message, the user may decide to raise their wrist and look at their watch. Detecting one or both of the predetermined gestures (e.g., the wrist raise gesture and the look down at device gesture) by the IMU may cause the audio to pause on the smart glasses, and may cause the text of the message to appear on the smart watch (e.g., a UI of the smart watch). A processor (e.g., processor 32), for example executing/implementing motion graphics, may indicate that the message content is transferring from the smart glasses (e.g., quick entrance/fade based on relative smart glasses position) to the smart watch. Additionally, formatting of the message text may indicate which part of the message the user has already heard from the audio output by the smart glasses, such that the user may start reading (e.g., text) beginning with the remainder of the message.

As yet another example of the method(s) of message delivery/output of the present disclosure, consider another example of transitioning a message output from a smart watch (e.g., smartwatch 112, device 310) to smart glasses (e.g., HMD 100). In this example, the user may be already looking at their smart watch as a new message arrives/is received. An IMU (e.g., IMU 56) associated with the smart watch and/or the smart glasses may determine that the user is already looking at the smart watch based on detecting one or more of the predetermined gestures (e.g., the wrist raise gesture and the look down at device gesture). The new message may be displayed in text by the smart watch, and the smart glasses may not take any action regarding the message. The user may see that the message is a very long message, and the user may need to get to their next meeting. As the user drops their wrist wearing the smart watch and looks up to start walking, the message delivery/output may transition from the text of the smart watch to audio of the content associated with the message output by the smart glasses. In this regard, the user may listen to the audio of the message output by the smart glasses as the user walks.

FIG. 5 illustrates a block diagram of an example hardware/software architecture of user equipment (UE) 30. In some examples, the UE 30 may be examples of HMD 100, device 310, mobile device 111, or smartwatch 112. As shown in FIG. 5, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54 and an IMU 56. In an example, the camera 54 is a smart camera configured to sense images appearing within one or more bounding boxes. The IMU 56 may include an accelerometer and a gyroscope. The accelerometer of the IMU(s) may measure/determine motion, acceleration, linear velocity and/or position associated with multiple axes (x-axis, y-axis, z-axis, etc.) relative to a reference frame. The gyroscope of the IMU 56 may measure/determine attitude, orientation and/or angular velocity associated with the multiple axes. In some examples, the determinations and/or measurements of the IMU 56 may be utilized by communication devices to determine one or more predetermined gestures which may be utilized, in part, to determine a manner in which to output of a message(s). In some examples, the predetermined gestures may be a wrist raise gesture and a look down at device gesture or any other suitable gestures. The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

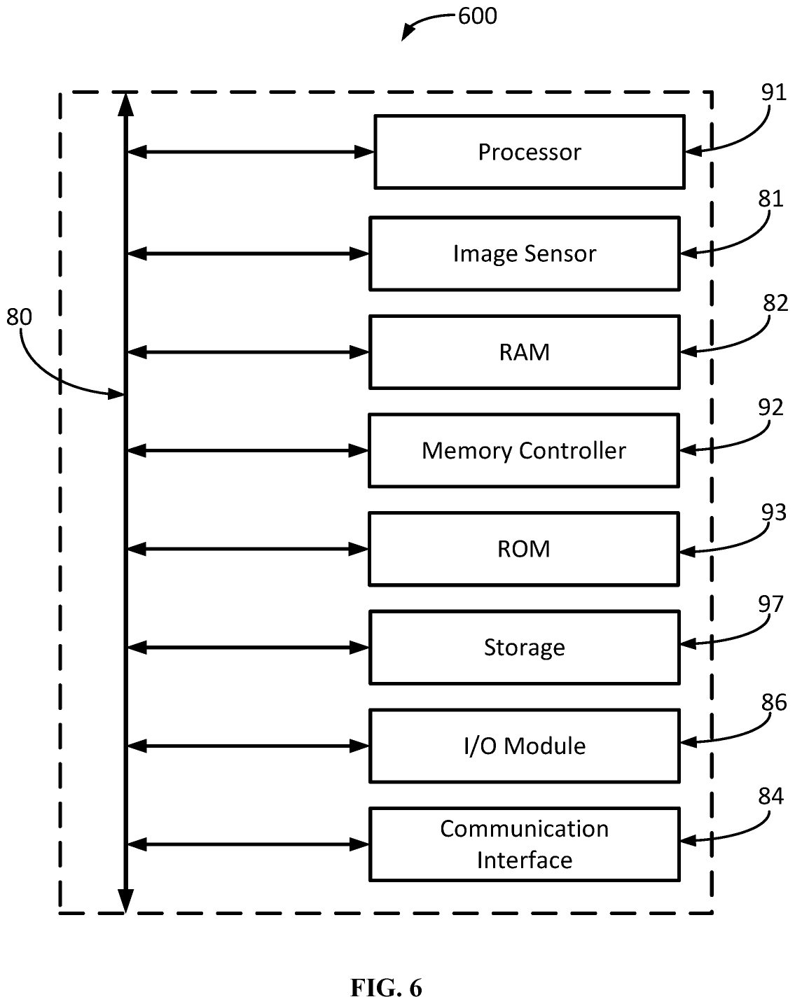

FIG. 6 illustrates an example schematic of an example processing system 600 that may implement components of the system or be part of the UE 30 of FIG. 5. The processing system 600 is only one example of a suitable processing system 600 within a device (e.g., mobile phone, laptop, tablet, or any device with messaging capabilities) and is not intended to suggest any limitation as to the scope of use or functionality of examples of the methodology described herein. The processing system 600 may comprise a computer or server and may be controlled primarily by computer readable instructions, which may be in the form of software, wherever, or by whatever means such software is stored or accessed. Such computer readable instructions may be executed within a processor, e.g., processor 91, to cause processing system 600 to operate. In operation, processor 91 fetches, decodes, and executes instructions, and transfers information to and from other resources via the processing systems 600 main data-transfer path, bus 80. Bus 80 connects the components in processing system 600 and defines the medium for data exchange. Bus 80 typically includes data lines for sending data, address lines for sending addresses, and control lines for sending interrupts and for operating the bus 80.

In particular examples, bus 80 includes hardware, software, or both coupling components of processing system 600 to each other. As an example and not by way of limitation, bus 80 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 80 may include one or more buses, where appropriate. Although this disclosure describes and illustrates a particular bus, this disclosure contemplates any suitable bus or interconnection.

Memories coupled to bus 80 include RAM 82 and ROM 93. Such memories may include circuitry that allows information to be stored and retrieved. ROMs 93 generally contain stored data that cannot easily be modified. Data stored in RAM 82 may be read or changed by processor 91 or other hardware devices. In some examples, access to RAM 82 and/or ROM 93 may be controlled by memory controller. A memory controller may provide an address translation function that translates virtual addresses into physical addresses as instructions are executed. Memory controllers may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In some examples, I/O interface 86 includes hardware, software, or both, providing one or more interfaces for communication between processing system 600 and one or more I/O devices. Processing system 600 may include one or more of these I/O devices, where appropriate. One or more of these I/O devices may enable communication between a person and processing system 600. As an example, and not by way of limitation, a I/O device may include a keyboard, keypad, microphone, monitor, mouse, printer, scanner, speaker, still camera, stylus, tablet, touch screen, video camera, another suitable I/O device, or a combination of two or more of these. An I/O device may include one or more sensors. This disclosure contemplates any suitable I/O devices and any suitable I/O interfaces for them. Where appropriate, I/O interface 86 may include one or more device or software drivers enabling processor 91 to drive one or more of these I/O devices. I/O interface 86 may include one or more I/O interfaces, where appropriate. Although this disclosure describes and illustrates a particular I/O interface, this disclosure contemplates any suitable I/O interface.

In some examples, storage 97 includes mass storage for data or instructions. As an example, and not by way of limitation, storage 97 may include a hard disk drive (HDD), flash memory, random access memory (RAM), read only memory (ROM), non-volatile read only memory (NVROM) or a Universal Serial Bus (USB) drive or a combination of two or more of these. Storage 97 may include removable or non-removable (or fixed) media, where appropriate. Storage 97 may be internal or external to processing system 600, where appropriate. In some examples, storage 97 is non-volatile, solid-state memory. In particular examples, storage 97 includes read-only memory (ROM). This disclosure contemplates mass storage taking any suitable physical form. Storage 97 may include one or more storage control units facilitating communication between processor 91 and storage 97, where appropriate. Where appropriate, storage 97 may include one or more storages 97. Although this disclosure describes and illustrates particular storage, this disclosure contemplates any suitable storage.

In some examples, communication interface 84 includes hardware, software, or both providing one or more interfaces for communication (such as, for example, packet-based communication) between processing system 600 and one or more other processing systems 600 or one or more networks. As an example, and not by way of limitation, communication interface 84 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface for it. As an example, and not by way of limitation, processing system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, processing system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Processing system 600 may include any suitable communication interface 84 for any of these networks, where appropriate. Communication interface 84 may include one or more communication interfaces 84, where appropriate. Although this disclosure describes and illustrates a particular communication interface, this disclosure contemplates any suitable communication interface.

The components of processing system 600 may include processor 91, RAM 82, ROM 93, memory controller 92, storage 97, input/output (I/O) interface 86, communication interface 84, and bus 80. Although the present disclosure describes and illustrates a particular processing system having a particular number of particular components in a particular arrangement, this disclosure contemplates any suitable processing system having any suitable number of any suitable components in any suitable arrangement.

In some examples, ROM 93 includes main memory for storing instructions for processor 91 to execute or data for processor 91 to operate on. Whereas RAM 82 may include temporary memory for possible transfer to main memory (e.g., ROM 93) when determined by the processor 91. As an example, and not by way of limitation, processing system 600 may load instructions from storage 97 or another source (such as, for example, another processing system 600) to ROM 93. Processor 91 may then load the instructions from ROM 93 to an internal register or internal cache. To execute the instructions, processor 91 may retrieve the instructions from the internal register or internal cache and decode them. During or after execution of the instructions, processor 91 may write one or more results (which may be intermediate or final results) to the internal register or internal cache. Processor 91 may then write one or more of those results to ROM 93 or RAM 82. In particular examples, processor 91 executes only instructions in one or more internal registers or internal caches or in ROM 93 or RAM 82 (as opposed to storage 97 or elsewhere) and operates only on data in one or more internal registers or internal caches or in ROM 93 or RAM 82 (as opposed to storage 97 or elsewhere).

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

In some examples, the processing system 600 may incorporate image capture for purposes of visual localization, or real time display of imagery captured of the local environment to support augmented reality functionality. In such examples, the processing system 600 may further include, for example, one or more image sensor 81. Plurality of image sensors 81 may be coupled, via bus 80, with processor 91, and operates to manage transfer of control signaling data between a processor 91 and the imaging sensor 81.

### B. Systems and Methods for Capturing Moments in the Past

### TECHNOLOGICAL FIELD

The present disclosure generally relates to systems, methods, and apparatuses for recording an environment.

### BACKGROUND

Electronic devices are constantly changing and evolving to provide the user with flexibility and adaptability. With increasing adaptability in electronic devices users are taking and keeping their devices on their person during various everyday activities. Constantly having electronic devices on your person may lead to users wanting to record their everyday scenery, surroundings, or themselves. It has become more common for users of electronic devices to want to capture or share their everyday surroundings. Although users may want to capture their surroundings, there may be instances where initiating a recording may cause the user to miss what the user wanted to capture or record. Therefore, with current devices a user may miss important moments in their surroundings.

In view of the foregoing drawbacks, it may be beneficial to provide an efficient and reliable mechanism for capturing or recording a user's surroundings prior to the initiation of a recording.

### SUMMARY

Methods and systems for a video recording system which may be associated with image or video capture for electronic devices (e.g., smartphones, smart glasses, artificial reality systems, or any device with a camera) are disclosed. The video recording system may include continuous capture of image data and/or video data for a predetermined time period (e.g., a predetermined number of seconds) stored in a temporary memory.

The examples of the present disclosure may provide a solution for head mounted devices that have cameras. In some examples, the cameras may be continuously streaming, but may not necessarily be recording image data or video data.

The streaming may start automatically, for example when a device detects that the user is performing an action (e.g., driving). However, recording may only take place based on specific triggers. Once a specific trigger is detected, the device may save the previous n seconds, where n is a number. The trigger may happen via motion cues, explicit enablement, and/or audio cues. An example trigger may be an audio cue stating “Hey Device, did you see that?”

After saving the capture (e.g., image capture and/or video capture), the device may prompt the user to decide whether or not to delete the recording. The device may also prompt the user on whether or not to continue recording.

In order to save power on the device, the initial streaming may happen at a reduced frame rate(s) and reduced quality. The quality and frame rate may be adaptive and may vary based on the scenario or use case. For example, in instances lower priority actions to the user such as, for example, driving, the device may record low quality images or videos. However, in instances of higher priority actions to the user such as, for example, interaction with a family member the device may record higher quality images or videos.

From a system standpoint, the device may disable processing of the images, until detecting receipt of the trigger to record. The device may store the raw sensor images in memory and may keep overwriting the raw sensor images while streaming. Once the device receives the trigger, the device may process these images and save them to a memory.

In some examples, a video recording system may include an image sensor to capture image data associated with an environment; a temporary memory for storing a predetermined time period (e.g., a predetermine number of seconds) of image data; detection of a trigger to initiate a recording; receiving a notification that the predetermined time period (e.g., the predetermined number of seconds) has been stored; displaying, via a display, an action menu for the user to decide an action(s) associated with a compiled recoding; a processor for processing image data captured, via an image sensor, in an instance in which the user wants to save or share the recording.

### DESCRIPTION

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another example includes from the one particular value and/or to the other particular value. Similarly, when values are expressed as approximations, by use of the antecedent “about,” it will be understood that the particular value forms another example. All ranges are inclusive and combinable. It is to be understood that the terminology used herein is for the purpose of describing particular aspects only and is not intended to be limiting.

A system, method and apparatuses may be presented that may record images of an environment in view of a camera. One example may include capturing a predetermined time period (e.g., a predetermined number of seconds) of the environment prior to a trigger, determining a trigger is performed to begin recording video, notifying a user that a predetermined time period prior to the trigger have been recorded, and prompting a user to decide an action(s) with recorded content or data. Then, based on the action(s) the image data may be deleted, saved, or shared and may result in processing of image data if recording data is not deleted.

The present disclosure is generally directed to systems and methods for recording video. Examples of the present disclosure may include a processor, an image sensor, a temporary memory, a memory controller, a long-term memory, and an input/output interface.

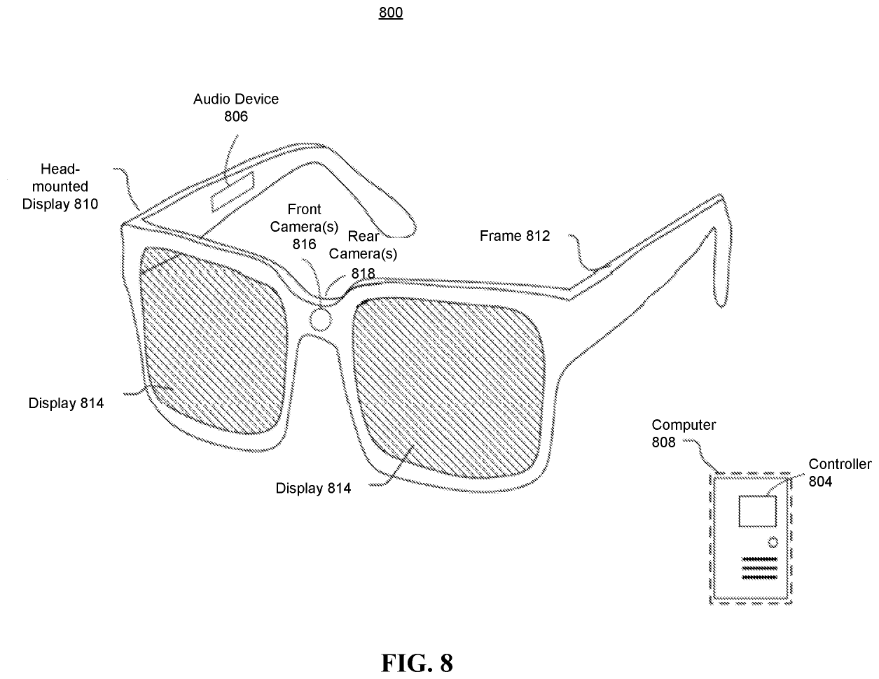

FIG. 8 illustrates an example recording device 800. For purpose of example and not of limitation, recording device 800 may be an artificial reality device or any device with a camera configured to record or capture images of an environment. The environment may be a real-world environment that a user may be within or may view with the artificial reality device. Recording device 800 may include a head-mounted display (HMD) 810 (e.g., smart glasses) comprising a frame 812, one or more displays 814, and a computing device 808 (also referred to herein as computer 808). The displays 814 may be transparent or translucent allowing a user wearing the HMD 810 to look through the displays 814 to see the real world (e.g., real world environment) and displaying visual augmented reality content to the user at the same time. The HMD 810 may include an audio device 806 (e.g., speakers/microphones) that may provide audio augmented reality content to users. The HMD 810 may include one or more cameras 816, 818 which may capture images or videos of environments. In one example, the HMD 810 may include a camera(s) 818 which may be a rear-facing camera tracking movement or gaze of a user's eyes.

One of the cameras may be a forward-facing camera (e.g., front camera 816) capturing images or videos of the environment that a user wearing the HMD 810 may view. The HMD 810 may include an eye tracking system to track the vergence movement of the user wearing the HMD 810. In one example, the camera(s) 818 may be the eye tracking system. In some examples, the camera(s) 818 may be one camera configured to view at least one eye of a user. In some other examples, the camera(s) 818 may include multiple cameras viewing each of the eyes of a user to enhance the capture of an image(s). The HMD 810 may include a microphone of the audio device 806 to capture voice input from the user. The recording system 800 may further include a controller 804 comprising a trackpad and one or more buttons. The controller 804 may receive inputs from users and relay the inputs to the computer 808. The controller 804 may also provide haptic feedback to one or more users. The computing device 808 may be connected to the HMD 810 and the controller 804 through cables or wireless connections. The computer 808 may control the HMD 810 and the controller 804 to provide the augmented reality content to and receive inputs from one or more users. In some examples, the controller 804 may be a standalone controller 804 or integrated within the HMD 810. The computer 808 may be a standalone host computer device, an on-board computer device integrated with the HMD 810, a mobile device, or any other hardware platform capable of providing augmented reality content to and receiving inputs from users. In some examples, HMD 810 may include an artificial reality system/virtual reality system.

In some alternate examples, HMD 810 may not include display 814. In this alternate example, the audio device 806, of the HMD 810, may provide an audio notification about a predetermined time period associated with recorded or captured data (e.g., images(s), video(s)) captured by a camera (e.g., front camera 806), even though in this example the recorded or captured content may not be displayed to the user wearing the HMD 810. In some examples, the audio notification may also be one or more audio signals.

Some portions of this description describe the examples in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

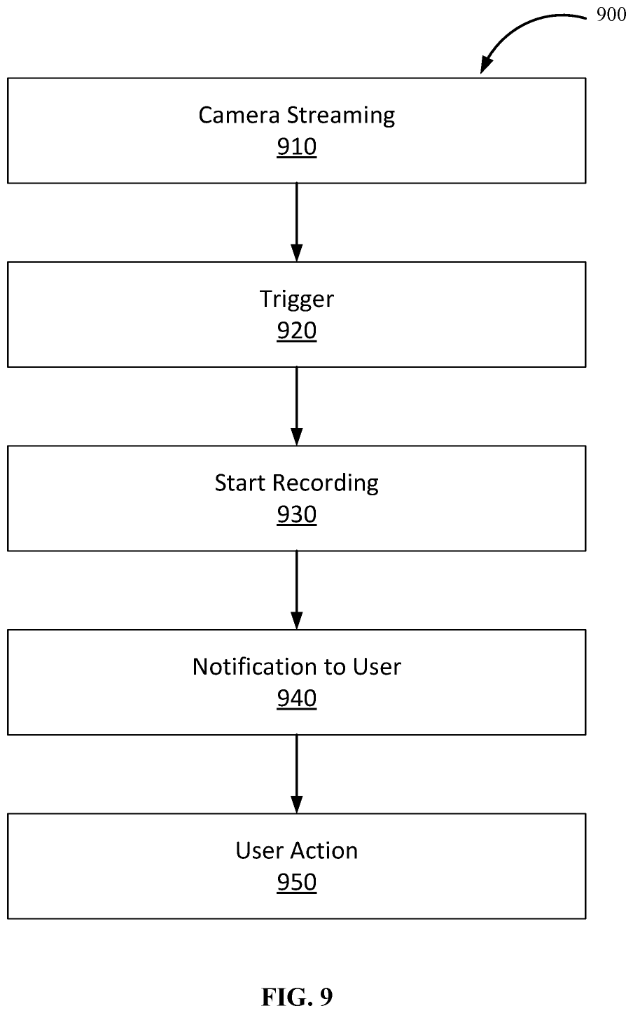

FIG. 9 is a flow diagram illustrating an example method 900 for video recording in accordance with an example of the present disclosure. The method 900 performed by one or more of processors (e.g., processor 91), memories (e.g., ROM 93 or RAM 82), image sensor(s) (e.g., image sensor 81), and/or a memory controller (e.g., memory controller 92). At step 910, light from an environment in the view of a camera (e.g., front camera 816) may be captured via an image sensor (e.g., image sensor 81) and may be stored temporarily in temporary memory (e.g., RAM 82), without an input from a user. Data captured by the image sensor may not be processed for viewing by the user of the recording device (e.g., recording system 800). Data captured and stored in in a memory such as RAM 82 may be overwritten or replaced every predetermined time period (e.g., a predetermined number of seconds). The time period in which RAM 82 may store data before it is replaced may be determined by the user of the recording device or device settings stored in storage (e.g., storage 97). For example, in an instance in which a user utilizes a recording device 800, the front camera 816 may capture an environment (e.g., a real-world environment) for 30 seconds, the device settings or user settings may be configured to store or retain the data captured from the camera for 5 seconds. Thus, every 5 seconds during the capture of 30 seconds of video or data captured via image sensor 81 may be overwritten by the next 5 seconds of video capture.

At step 920, a user may trigger a recording. A trigger may be any audio, visual, motion, or touch captured by a device. In the example of an audio trigger, a user may say any suitable word or string of words captured via a microphone of the recording device 800. Audio may also be determined by any other suitable method, function, or sensor. In the example of touch, a user may touch a button or an area of the recording device 800 or the computer 808 to initiate a recording. The touch may be determined via a pressure sensor threshold being met, where the pressure sensor threshold is set via device settings and may be stored in the storage (e.g., storage 97). Touch may also be determined by any other suitable method, function, or sensor. In the example of a visual trigger, the image sensor 81 may be configured to discern or determine hand movements or gestures to initiate a recording depicted by device settings. For example, the image sensor 81 may be configured to determine an instance in which a user's hand is raised to a predetermined level or height associated with the line of sight of a user. As such, in an instance in which the user's hand may be raised to the predetermined level or height, a recording of content may be initiated by recording device 800. As an example of a motion trigger, motion may be captured via a motion sensor of the recording device 800, in which the motion sensor may be configured to determine abrupt changes in motion to initiate a recording of content. Motion may also be determined by any other suitable method, function, or sensor.

At step 930, the last portion of the predetermined time period (e.g., a predetermined number of seconds) of captured recording may be saved to disk of a longer-term memory (e.g., ROM 93). The predetermined time period (e.g., the predetermined number of seconds) of captured image data may be transferred from RAM 82 to ROM 93. This transfer from temporary memory to long-term memory may be performed via memory controller 92 or processor 91. The predetermined time period may be determined via user or device settings and stored in storage 97. For example, if the predetermined time period is 5 seconds, when a user triggers a video recording the 5 seconds of image data or recording data may be moved from RAM 82 to ROM 93. Once recording is initiated, the user may see/view what is happening in an environment (e.g., real-world environment) or what is being recorded in real time. In examples where the recording device may be an HMD capable of presenting artificial reality content, the recording may comprise what is displayed (e.g., artificial reality content) to the user via HMD and the environment captured by the front camera (e.g., front camera 816). The view of the artificial reality content displayed on the display of an HMD and the environment captured by the front camera 816 may be displayed to the user in any arrangement (e.g., split screen, separately, overlayed, picture in picture (PIP), or any other suitable viewing arrangement) determined by user settings. The arrangement of the recording may also be determined by the user after the creation of the recording, during the initiation of the recording, or any suitable manner for the user to determine what the user would like to see or be recorded.

At step 940, the user may be notified via display of recording device that the last portion of the predetermined time period (e.g., a predetermined number of seconds) has been saved and that a recording has begun. At step 950, the user may select via the notification what the user would like to do with the predetermined time period prior to the trigger or initiation of the recording. The user may determine to continue the recording with the predetermined time period recorded prior to a trigger being considered for the first portion of the predetermined time period of the initiated recording. For example, if the predetermined time period is 10 seconds and a user decides to continue a recording for 50 seconds, the total length of the recorded video may be 60 seconds with the first 10 seconds comprising image data 10 seconds before the recording trigger. The user may also decide to delete the first portion (e.g., a number of seconds) of the predetermined time period recorded prior to the trigger. For example, if the first portion of the predetermined time period is 10 seconds and a user decides to delete the recording prior to the trigger, the recording may start at the trigger. As such, in this example, if a user records an environment for 50 seconds after the trigger, the resultant recording may be 50 seconds without the recording of the 10 seconds that occurred prior to the trigger.

In previous examples, the user may decide what to do with the predetermined time period (e.g., a predetermined number of seconds) of recording prior to the trigger at the start of the triggered video recording. In some other examples, the user may decide what to do with the recording comprising the predetermined time period of recording data after the completion of a recording. In such examples, the user may be prompted after the video to delete, save, or share the video. In examples where the user may decide to delete the recorded video, the user may be further prompted to decide to delete the compiled video, or the portion of the video captured prior to the trigger. In instances where the user decided to delete the recorded video prior to the trigger, the image data of the remaining video may be processed via a processor (e.g., processor 91), for viewing by the user, where the processing may comprise increasing resolution of image data captured by the image sensor. In examples where the user may decide to save the video, the recorded video including the predetermined time period recorded prior to trigger (also referred to as a compiled recorded video) may be saved to the device and processed, via processor (e.g., processor 91), to improve resolution of image data captured by image sensor for viewing by the user. In examples where the user may decide to share the video, the video may be processed via a processor (e.g., processor 91), saved, and sent to another device or platform. The shared video may be shared to any device or application on the user device via Wi-Fi, BLUETOOTH, email, short message service (SMS) message, multimedia message service (MMS) message or any other suitable means for sharing a recorded video.

For example, the method 900, may be used while a user is at a concert and wearing smart glasses. In this example, the user may have decided that they want to capture 30 seconds prior to a trigger of a recording. The user may experience an artist's performance and may want to capture the details of the concert for future purposes, such as sharing via social media platforms, between friends via messaging, etc. Since the user is wearing smart glasses, the environment seen by the camera is being recorded and the captured image data is being saved to temporary memory (e.g., RAM 82). The captured image data may be being overwritten every 30 seconds to save disk usage on the smart glasses' device. The user may now experience a concert and want to start a recording. Thus, the user may say a phrase such as “Did you see that?” to trigger the start of a video recording. When the user triggers the video recording, a notification may be presented to the user informing the user that the last 30 seconds have been saved or recorded. Once the user ends the recording, the user may be prompted to save, delete, or share the recorded video. In this example, the user may want to share the video with a social media platform, family, or any interested party, etc. The user may also want to save the video for their own records. In either option of sharing the video or saving the video, the image data captured may be processed, where the resolution of the video may be improved.

In another example, the method 900, may be used while a user is driving a vehicle and wearing smart glasses. In this example, the user may have decided that they want to capture 45 seconds prior to a trigger of a recording. The user may experience a car accident with another driver and want to capture the details of the accident for insurance purposes. Since the user is wearing smart glasses, the real-world environment seen by the camera may be recorded and the captured image data may be saved to temporary memory (e.g., RAM 82). The captured image data may be being overwritten every 45 seconds to save disk usage on the smart glasses' device. The user may now experience an accident, thus initiating a motion trigger as the user may experience an abrupt change in motion as determined via motion sensor of the smart glasses' device. Thus, the motion caused by the accident may trigger the start of a video recording. When the motion triggers the video recording, a notification may be presented to the user informing the user that the last 45 seconds have been saved or recorded. Once the user ends the recording, the user may be prompted to save, delete, or share the recorded video. In this example, the user may want to share the video with an insurance application (app), family, or any interested party, etc. The user may also want to save the video for their own records. In either option of sharing the video or saving the video, the image data captured may be processed, and the resolution of the video may be improved.

Below are additional features that may be incorporated into the methods, systems, or devices disclosed herein.

### AI Recalling Information Based on Visual Data

### TECHNOLOGICAL FIELD

The present disclosure generally relates to systems, methods, and apparatuses for recording or recalling information associated with an environment.

### BACKGROUND

Electronic devices are constantly changing and evolving to provide the user with flexibility and adaptability. With increasing adaptability in electronic devices users are taking and keeping their devices on their person during various everyday activities. Constantly having electronic devices on your person may lead to users wanting to record their everyday scenery, surroundings, or themselves. It has become more common for users of electronic devices to want to capture or share their everyday surroundings. Although users may want to capture their surroundings, there may be instances where initiating a recording may cause the user to miss what the user wanted to capture (e.g., record). Therefore, with current devices a user may miss important moments in their surroundings.

In view of the foregoing drawbacks, it may be beneficial to provide an efficient and reliable mechanism for capturing a user's surroundings or recalling information associated with what has been captured.

AI recall of information based on visual data lets an AI Large Language Model recall information based on screen visuals. For instance, if this feature was enabled, if you pulled up your airline travel application on a mobile device (or other device), the AI recognize the users gate number and a map of the airport automatically. You could then later ask it which gate you are meant to be at and how to get there, and it would know that information not from code or metadata, but because it actually saw the visual on your device of the map and gate number.

Information may need to be coded and passed along to an AI for it to understand and retain it. The disclosed subject matter may provide a way for an AI to learn how to use applications and software in a visual way, not a hardcoded way, which may enhance the flexibility of AI models to use other software. A device may retain information by sampling a device screen visual. This may be used in any number of devices, such as HMDs or wrist devices.

### Automatically Invoking a Camera or Invoking an AI Assistant Using a Symbol & Leveraging Hand Gestures for Artificial Reality Devices to Act on a QR Code

### TECHNOLOGICAL FIELD

The present disclosure generally relates to systems, methods, and apparatuses for recording or recalling information associated with an environment.

### BACKGROUND

Electronic devices are constantly changing and evolving to provide the user with flexibility and adaptability. With increasing adaptability in electronic devices users are taking and keeping their devices on their person during various everyday activities. Constantly having electronic devices on your person may lead to users wanting to record their everyday scenery, surroundings, or themselves. It has become more common for users of electronic devices to want to capture or share their everyday surroundings. Although users may want to capture their surroundings, there may be instances where initiating a recording may cause the user to miss what the user wanted to capture or record. Therefore, with current devices a user may miss important moments in their surroundings.

In view of the foregoing drawbacks, it may be beneficial to provide an efficient and reliable mechanism for capturing a user's surroundings or recalling information associated with what has been captured.

Symbol based firing of AI proposes a quick-response (QR) code or other symbol (e.g., gesture) to automatically fire the camera (or other detection device) to ask the user's AI assistant to “remember something.” There may be QR codes that automatically send a text message or join a Wi-Fi network, so, in an example, the disclosed symbol may wake the user's camera, take a photo, and then submit that visual information to the user's AI assistant as data to remember. In an example, this feature may be used in an instance in which a user might take a photo in order to remember something, like a sign indicating where the user parked or a receipt. A symbol may be used automatically to record or invoke an AI assistant.

Note that the features may be combined throughout. For example, an end user may tag certain visuals based on gestures (e.g., performing a gesture(s) while recording via an HMD) or tagging via mobile device applications or the like. This tagging may be used to train a model so that other users may not need to tag or otherwise make use of the symbol in subsequent instances. In another example, a device (e.g., an HMD) may wake on recognition of a visual QR code, and then start the camera or use an inertial measurement unit to recognize that the user has raised their hand to act on the recognized QR code. The camera may then be used to check if the user has, for instance, made an “L” shape (e.g., an L shaped gesture) with their hands, or pointed at the QR code to access it.

Querying an AI about a QR Code Payload

### TECHNOLOGICAL FIELD

The present disclosure generally relates to systems, methods, and apparatuses for recalling information associated with an environment.

### BACKGROUND

Electronic devices are constantly changing and evolving to provide the user with flexibility and adaptability. With increasing adaptability in electronic devices users are taking and keeping their devices on their person during various everyday activities. Constantly having electronic devices on your person may lead to users wanting to record their everyday scenery, surroundings, or themselves. It has become more common for users of electronic devices to want to capture or share their everyday surroundings. Although users may want to capture their surroundings, there may be instances where initiating a recording may cause the user to miss what the user wanted to capture or record. Therefore, with current devices a user may miss important moments in their surroundings.

In view of the foregoing drawbacks, it may be beneficial to provide an efficient and reliable mechanism for capturing a user's surroundings or recalling information associated with what has been captured.

A user might smart glasses or other device to look at a QR code (or other code), which may be for a website or other information (e.g., a menu). The smart glasses may automatically load the webpage without ever displaying it to the user, who could then query about its contents of the web page-like, “do they have chicken nuggets?” or “do they have gluten-free items?” without ever having to look at the actual menu or loaded webpage. A user might not want to use their device to load information (e.g., website) via code (e.g., QR code), and they might just want to ask an AI assistant about the contents that may have been displayed (e.g., on a laptop or mobile phone).

The following regarding AI and affiliated areas may be considerations in implementing the subject matter disclosed in this application. For example, the use of LLMs to detect what may be considered significant information to quickly incorporate and use in recalling visual data.

Artificial intelligence is the practice of developing machines that are able to behave in a capacity that far exceeds that which humans can do within a feasible amount of time. AI is situated to function without human intervention. The purpose of AI is to enable programs that are capable of data analysis and contextualization. Within an AI system there are 5 key operative goals: learning, reasoning, problem solving, perception, and using language. The four subsidiary areas of functionality are machine learning, deep learning, natural language processing, and computer vision. Data Science is closely related and depends on AI to execute its goals.

Machine Learning (ML) is a subsidiary of AI. Within ML, algorithms are used to inform the behaviors of the system. This is done via training data and the recognition of patterns. There are many subsidiaries associated with ML, including but not limited to, Supervised Learning, Unsupervised Learning, Semi-supervised Learning, or Reinforcement Learning.

Training data is the information that is gathered and given to the system to develop a repertoire of situational actions and responses. Training is typically done all together and may include multiple pieces of data being input into the system in order to examine patterns and develop predictions.

Models reference the trained data when processing unseen data and make informed decisions surrounding classification and next steps to be taken. The data processing step generally may include computational methods which helps the machine “learn.”

Natural Language Processing is directly connected to the roots of linguistics. The AI subsidiary has the ability to understand human language as it is written and spoken. When NLP is utilized, text can be translated from one to another. NLP can also be used to process and respond to verbal commands and synthesize large amounts of text in efforts to create a summary. Some examples of this include but are not limited to digital assistants, GPS, dictation services and several other convenient methods for engaging a vendor.

Large language models (LLMs) are a form of deep learning algorithm and can perform a substantial number of tasks associated with natural language processing. LLMs are trained using large databases, which enables the model to complete several tasks including predicting, translating, recognizing, and generating text.

Data Science is utilized to synthesize and process historical information and identify patterns to make predictions. This is a symbiotic relationship as AI is trained with substantial amounts of information that can be utilized to create and devise outcomes that are beneficial to the system or person responsible for the data applications. The languages for data science include but are not limited to Python, SQL, R, and others. Additionally, statistical analysis is integral to the success of the internal models used for execution. Other areas of emphasis include distributed architecture and data visualization. Both are utilized to decipher the significance of each data element. This routine generally consists of two parts: predictive casual analytics and prescriptive analysis. Predictive casual analytics is most efficient when used for business forecasts and financial planning. The basis of this model is rooted in the processing of data to display several outcomes based upon calculation of the variables. Prescriptive analysis is optimized for the setting of a goal or desired metric. The inferences made by the predictive model are best suited for manipulating variables to meet the desired parameters set by the system or user.

The foregoing description of the embodiments has been presented for the purpose of illustration; it is not intended to be exhaustive or to limit the patent rights to the precise forms disclosed. Persons skilled in the relevant art may appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which may be executed by a computer processor for performing any or all of the steps, operations, or processes described.

Embodiments also may relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

What is claimed:

1. An apparatus comprising:
at least one processor; and
a memory coupled with the at least one processor, the memory including computer executable instructions, which when executed by the at least one processor, cause the apparatus to:
receive at least one message;
determine whether a movement of a communication device associated with a user has reached a predetermined threshold;
determine a message delivery process based on the movement relative to the predetermined threshold, wherein the message delivery process comprises:
outputting the message via text by the communication device in an instance in which the movement reached or exceeded the predetermined threshold;
outputting the message via audio to a head-mounted display (HMD) associated with the user, in an instance in which the movement is below the predetermined threshold; and
monitor one or more movements or positions during the outputting of the message,
wherein mode of outputting is adjusted based on:
movement changes from text on the electronic device to audio to the HMD when the movement level changes from reaching the predetermined threshold to the rest level; and
change in mode of delivery from audio on the HMD to text on the electronic device when the movement level changes from the rest level to the predetermined threshold, wherein text that has been delivered via audio prior to the change is gray to help the user know where to start reading.

2. An apparatus comprising:
at least one processor; and
a memory coupled with the at least one processor, the memory including computer executable instructions, which when executed by the at least one processor, cause the apparatus to:
receive a message;
determine a movement level of a head-mounted device (HMD) associated with a user has reached a predetermined threshold;
determine a message delivery process based on the movement level relative to the predetermined threshold, wherein:
delivering the message via text on an electronic device associated with the user when the movement level reached the predetermined threshold;
delivering the message via audio associated with the message to the HMD associated with the user, wherein the movement level is at a rest level; and
monitoring the movement level during delivery of the message, wherein mode of delivery adjusts, wherein:
changing a mode of delivery from text on the electronic device to audio by the HMD when the movement level changes from reaching the predetermined threshold to the rest level; and
changing a mode of delivery from audio on the HMD to text by the electronic device when the movement level changes from the rest level to the predetermined threshold, and wherein audio associated with text of the message that has been output prior to the change comprises a different format to enable the user to determine where to start reading the text.

3. A method comprising:
capturing image data or video data via an image sensor of an environment continuously;
storing a predetermined time period of captured image data or video data in a temporary memory;
detecting a trigger from a user to initiate a recording, wherein the detecting comprises receiving image data or video data associated with a quick-response code or gesture; and
based on the detecting, sending a notification to store the captured image data or video data for use in a machine learning application.
